(19) United States
(12) Patent Application Publication
(10) Pub. No.: US 2024/0332990 A1
(43) Pub. Date: Oct. 3, 2024

(54) BATTERY SYSTEM

(71) Applicant: Prime Planet Energy & Solutions, Inc., Tokyo (JP)

(72) Inventor: Junya YANO, Kato-shi (JP)

(21) Appl. No.: 18/616,187

(22) Filed: Mar. 26, 2024

(30) Foreign Application Priority Data
Mar. 30, 2023 (JP) 2023-055087

(51) Int. Cl. H02J 7/00

(52) U.S. Cl. CPC H02J 7/0016; H02J 7/007182

(57) ABSTRACT

A battery system includes a plurality of battery units connected in parallel, a battery unit voltage detector detecting a voltage value of the battery units, a plurality of unit relays respectively connected in series to the plurality of battery units, and at least one balancing circuit. The battery units each includes a plurality of battery cells connected in series, a cell voltage detector, and an equalizer equalizing remaining capacities of the plurality of battery cells. The balancing circuit includes a resistor. One end of the balancing circuit is connected to a connection point between one of the battery units and one of the unit relays that are connected in series. The other end of the balancing circuit is connected to a connection point between another one of the battery units and another one of the unit relays that are connected in series.

### CROSS REFERENCE TO RELATED APPLICATIONS

The present application claims priority from Japanese Patent Application No. 2023-055087 filed on Mar. 30, 2023, which is incorporated by reference herein in its entirety.

### BACKGROUND

The present disclosure relates to battery systems.

WO 2012/043723 discloses a power supply device equipped with a storage battery including a plurality of battery units connected via a parallel line, a power supply that charges the battery units constituting the storage battery, a pre-connection circuit that connects the battery units to the parallel line, a main switch that connects the battery units between which the voltage difference is eliminated by the pre-connection circuit to the parallel line, and a control circuit. The pre-connection circuit includes a series circuit of a current-limiting resistor and an equalizing switch. The control circuit controls turning on and off of the equalizing switch of the pre-connection circuit and the main switch. The control circuit switches on the equalizing switch of the pre-connection circuit in a state in which the difference between the voltage of the parallel line and the battery units becomes smaller than a set voltage. This equalizes the voltage of the battery units to the voltage of the parallel line. The equalized battery units are connected to the parallel line through the main switch that is turned on by the control circuit. It is stated that such a power supply device is able to reduce the amount of heat produced by the current-limiting resistor.

JP 2011-72153 A discloses a vehicle power supply device equipped with a battery block in which a plurality of battery units are connected in parallel, a unit switch connected in series with each of the battery units, a cell voltage detection circuit detecting the cell voltage of the battery cells that constitute the battery units, a cell capacity equalization circuit reducing variations in battery remaining capacity between the battery cells that constitute the battery units based on the cell voltage detected by the cell voltage detection circuit, a unit voltage detection circuit detecting a unit voltage that is the total voltage of the battery units, a unit capacity equalization circuit reducing variations in battery remaining capacity between the battery units based on the unit voltage detected by the unit voltage detection circuit, and a power supply controller. The power supply controller controls the cell capacity equalization circuit to equalize the cell remaining capacity individually for each of the battery units, and thereafter controls the unit capacity equalization circuit to equalize the unit remaining capacity between the battery units for the entire battery block. It is stated that such a vehicle power supply device is able to eliminate the imbalance between the battery units effectively.

JP 2018-60641 A discloses a vehicular power supply device equipped with a first power storage device including a first power storage element, a second power storage device including a second power storage element, a switch for switching the first power storage device and the second power storage device to a state in which they are connected in parallel and to a state in which they are disconnected, and a switch control section. The first power storage element and the second power storage element have a flat region in SOC-OCV characteristic curve. The switch control section turns the switch from off to on when the first power storage element and the second power storage element are in the flat region of the SOC-OCV characteristic curve. It is said that such a power supply device can prevent large current from passing through the switch in switching of the switch.

### SUMMARY

The present inventor intends to make the start-up of a battery system including a plurality of batteries quicker.

A battery system according to the present disclosure includes a plurality of battery units connected in parallel, a battery unit voltage detector detecting a voltage value of each of the battery units, a plurality of unit relays respectively connected in series to the plurality of battery units, and at least one balancing circuit. Each of the plurality of battery units includes a plurality of battery cells connected in series, a cell voltage detector detecting respective voltage values of the plurality of battery cells, and an equalizer equalizing remaining capacities of the plurality of battery cells based on the voltage values detected by the cell voltage detector. The balancing circuit includes a resistor. One end of the balancing circuit is connected to a connection point between one of the battery units and one of the unit relays that are connected in series. The other end of the balancing circuit is connected to a connection point between another one of the battery units and another one of the unit relays that are connected in series. The just-described battery system is able to start up quickly.

### BRIEF DESCRIPTION OF THE DRAWINGS

FIG. 1 is a schematic view illustrating a battery system 1.

FIG. 2 is a flowchart illustrating a process executed by a controller 50.

FIG. 3 is a schematic view illustrating a battery system 1A.

FIG. 4 is a schematic view illustrating a battery system 1B.

FIG. 5 is a flowchart illustrating a process executed by the controller 50.

FIG. 6 is a schematic view illustrating a battery system 1C.

FIG. 7 is a flowchart illustrating a process executed by the controller 50.

### DETAILED DESCRIPTION

Hereinbelow, embodiments of the technology according to the present disclosure will be described with reference to the drawings. It should be noted, however, that the disclosed embodiments are, of course, not intended to limit the disclosure. The drawings are depicted schematically and do not necessarily accurately depict actual objects. The features and components that exhibit the same effects are designated by the same reference symbols as appropriate, and the description thereof will not be repeated as appropriate.

### Battery System 1

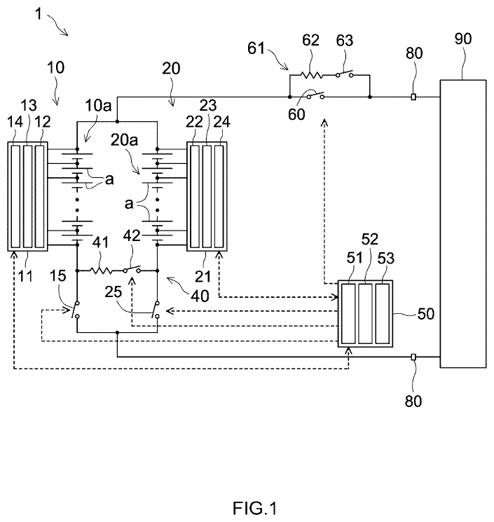

FIG. 1 is a schematic view illustrating a battery system 1. As illustrated in FIG. 1, the battery system 1 includes battery units 10 and 20, battery unit voltage detectors 14 and 24, unit relays 15 and 25, and a balancing circuit 40. The battery units 10 and 20 are connected in parallel. The battery system 1 includes an output terminal 80. The battery units 10 and 20 connected in parallel are connected in series to a load 90 via the output terminal 80. The load 90 may include, but not be particularly limited to, an electric motor, an inverter, or the like of a vehicle, for example. The load 90 may convert the electric power from the battery units 10 and 20 into motive power or may supply regenerative power to the battery units 10 and 20. The load 90 may be connected to a smoothing capacitor for reducing abrupt changes in electric current. Note that the load 90 is not limited to such an embodiment.

The battery system 1 includes a main relay 60 and a controller 50. The main relay 60 is connected in series to the battery units 10 and 20 connected in parallel. The main relay 60 is a relay that switches on and off the connection between the battery system 1 and the load 90. The main relay 60 is disposed between the output terminal 80 and the battery units 10 and 20 connected in parallel. The main relay 60 is disposed on the positive electrode side of the battery units 10 and 20. The battery system 1 further includes a pre-charge circuit 61. The pre-charge circuit 61 is connected in parallel to the main relay 60.

The pre-charge circuit 61 is a circuit including a pre-charge resistor 62 and a pre-charge relay 63 that are connected in series. The pre-charge circuit 61 is a circuit that prevents inrush current from flowing into the load 90 when electric power is supplied from the battery system 1 to the load 90. Before the load 90 is started up, the main relay 60 and the pre-charge relay 63 are in an off state. At the time of starting up the battery system 1 connected to the load 90, the pre-charge relay 63 is switched to an on state. The load 90 is connected to the battery system 1 via the pre-charge circuit 61. At that time, because the pre-charge circuit 61 is provided with the pre-charge resistor 62, the load 90 is supplied with electric power at a low current from the battery unit 10. Thereafter, with the potential of the load 90 being raised, the main relay 60 is closed and the pre-charge relay 63 is opened. This prevents large current from flowing into the load 90. When connecting the battery system 1 to the load 90, it is possible that the pre-charge relay 63, the main relay 60, and later-described unit relays 15 and 25 may be controlled so that the smoothing capacitor is pre-charged.

### Battery Unit 10

The battery unit 10 includes a plurality of battery cells a connected in series and a battery controller 11. The plurality of battery cells a is a group of batteries in which a predetermined number of battery cells a are connected in series via a bus bar (hereinafter, the plurality of battery cells a of the battery unit 10 may also be referred to collectively as a battery module 10a). The battery module 10a may further include one or plurality or battery cells a connected in parallel. Each of the battery cells a may be a secondary battery in which repeated charging and discharging are possible by means of migration of charge carriers through an electrolyte between a pair of electrodes (positive electrode and negative electrode). Each of the battery cells a may be a lithium-ion secondary battery, a nickel-metal hydride battery, or the like, for example. The remaining capacities of the batteries in the battery module 10a may be controlled by the battery controller 11.

The battery unit 10 is connected in series to a unit relay 15. The unit relay 15 is a relay that switches on and off the connection between the battery unit 10 and the load 90. The unit relay 15 is connected between battery unit 10 and the output terminal 80. In this embodiment, the unit relay 15 is connected to the negative electrode side of the battery module 10a that constitutes the battery unit 10. Note that the unit relay 15 may alternatively be connected in series to positive electrode side of the battery module 10a.

### Battery Controller 11

The battery controller 11 includes a cell voltage detector 12 and an equalizer 13. In this embodiment, the battery controller 11 includes a battery unit voltage detector 14. The battery controller 11 is communicably connected to the controller 50. The cell voltage detector 12 detects respective voltage values of the plurality of battery cells a that constitute the battery module 10a. The cell voltage detector 12 may be implemented by a circuit that can detect respective voltage values of the battery cells a. The cell voltage detector 12 may include a plurality of connecting terminals connected respectively to the positive electrodes and the negative electrodes of the battery cells a that constitute the battery module 10a, for example.

The equalizer 13 equalizes the remaining capacities of the plurality of battery cells a based on the voltage values detected by the cell voltage detector 12. The equalizer 13 is not limited to any particular configuration as long as it can equalize the remaining capacities of the plurality of battery cells a. The equalizer 13 may be implemented by a conventionally known equalizer circuit. Although not shown in detail in the drawings, the equalizer 13 may be implemented by a control circuit and a plurality of discharge circuits connected between a plurality of connecting terminals connected to the positive electrodes and the negative electrodes of the battery cells a. Each of the plurality of discharge circuits may include a discharge resistor and a switching element. The control circuit may be configured to be able to acquire the respective voltage values of the plurality of battery cells a from the cell voltage detector 12. The control circuit may acquire the respective voltage values of the plurality of battery cells a from the cell voltage detector 12, for example, via a multiplexer, which is not shown in the drawings. The control circuit may be configured to be able to execute a process of switching the switching element between an on state and an off state based on the acquired voltage values to cause the voltage of a battery cell a having a higher voltage to a battery cell a having a lower voltage.

The battery unit voltage detector 14 detects a voltage value of the plurality of battery cells a connected in series (i.e., battery module 10a). The battery unit voltage detector 14 may be implemented by a circuit that can detect the voltage value of the battery module 10a. The battery unit voltage detector 14 may include a plurality of connecting terminals connected respectively to the positive electrode and the negative electrode of the battery module 10a. The battery unit voltage detector 14 may be composed of a device that sums up the respective voltage values of the battery cells a constituting the battery module 10a, which are detected by the cell voltage detector 12. The voltage value of the battery module 10a acquired by the battery unit voltage detector 14 is transmitted to the controller 50.

### Battery Unit 20

The battery unit 20 is connected in parallel to the battery unit 10 The battery unit 20 includes a plurality of battery cells a connected in series (hereinafter, the plurality of battery cells a of the battery unit 20 may be referred to collectively as a battery module 20a) and a battery controller 21. The battery unit 20 is connected in series to a unit relay 25. The unit relay 25 is a relay that switches on and off the connection between the battery unit 20 and the load 90. The unit relay 25 is connected to the negative electrode side of the battery module 20a that constitutes the battery unit 20.

The battery controller 21 includes a cell voltage detector 22 and an equalizer 23. The cell voltage detector 22 detects respective voltage values of the plurality of battery cells a that constitute the battery module 20a. The equalizer 23 equalizes the remaining capacities of the plurality of battery cells a based on the voltage values detected by the cell voltage detector 22. The battery controller 21 includes a battery unit voltage detector 24. The battery controller 21 is communicably connected to the controller 50. The voltage value of the battery module 20a acquired by the battery unit voltage detector 24 is transmitted to the controller 50. The battery unit 20 has the same configuration as the battery unit 10 and will therefore not be further described in detail.

As described above, in the battery system 1, the remaining capacities of the battery cells a that constitute the battery modules 10a and 20a may be equalized by the cell voltage detectors 12 and 22 and the equalizers 13 and 23.

In cases where the remaining capacities of a plurality of battery units are significantly different between the battery units even through the remaining capacities of the plurality of battery cells in each of the battery units are equalized, there is a risk that problems may arise when the plurality of battery units are connected in parallel. When a plurality of battery units having different remaining capacities are connected in parallel, electric current may flow from one battery unit having a higher remaining capacity to another battery unit having a lower remaining capacity. At that time, the greater the difference in remaining capacity, the larger the current that flows between the battery units may be. Such a large current between the battery units may cause damages to the battery cells, the unit relays, and so forth. For this reason, when the difference in remaining capacity between the battery units is great, it is necessary to equalize the remaining capacities between the battery units when the battery system is started up.

The battery system 1 enables the remaining capacities between the battery units 10 and 20 to be equalized. The battery system 1 enables the remaining capacities between the battery units 10 and 20 to be equalized by the balancing circuit 40.

### Balancing Circuit 40

The balancing circuit 40 includes a resistor 41 and a balancing relay 42. In this embodiment, the balancing circuit 40 is a circuit in which the resistor 41 and the balancing relay 42 are connected in series. One end of the balancing circuit 40 is connected to a connection point between the battery unit 10 and the unit relay 15 that are connected in series. The other end of the balancing circuit 40 is connected to a connection point between the battery unit 20 and the unit relay 25 that are connected in series. In other words, the balancing circuit 40 is connected so as to connect a point between the battery unit 10 and the unit relay 15 and a point between the battery unit 20 and the unit relay 25. By switching the balancing relay 42 to an on state, the battery units 10 and 20 are connected in parallel even when the unit relays 15 and 25 are in an off state. The switching of the balancing relay 42 may be controlled by the controller 50.

### Controller 50

The controller 50 controls switching of the main relay 60, the pre-charge relay 63, the unit relays 15 and 25, and the balancing relay 42. The controller 50 includes, for example, a communication interface, a CPU, a ROM, and a RAM. The controller 50 includes an acquisition unit 51, a determination unit 52, and an instruction unit 53. The acquisition unit 51 acquires voltage values transmitted from the battery controllers 11 and 21. The determination unit 52 determines whether or not the relays are to be switched based on the voltage values of the battery units 10 and 20. The instruction unit 53 instructs switching of switching of the main relay 60, the pre-charge relay 63, the unit relays 15 and 25, and the balancing relay 42. The acquisition unit 51, the determination unit 52, and the instruction unit 53 may be implemented by, for example, a plurality of processors.

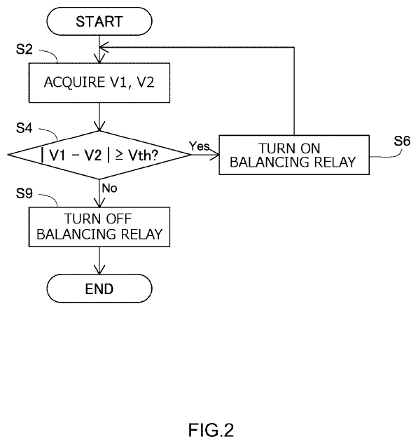

FIG. 2 is a flowchart illustrating a process executed by the controller 50. FIG. 2 shows a flowchart of a process that is executed when the remaining capacities between the battery units 10 and 20 are equalized. In this embodiment, the equalization in remaining capacity between the battery units 10 and 20 is performed before the battery units 10 and 20 of the battery system 1 are connected to the load 90. Before the battery units 10 and 20 are connected to the load 90, the main relay 60, the pre-charge relay 63, the unit relays 15 and 25, and the balancing relay 42 are in an off state.

At step S2 shown in FIG. 2, the acquisition unit 51 acquires a voltage value V1 of the battery unit 10 and a voltage value V2 of the battery unit 20.

At step S4 shown in FIG. 2, the determination unit 52 determines whether or not the difference between the voltage value V1 and the voltage value V2, acquired by the acquisition unit 51, is greater than or equal to a predetermined specified voltage value Vth. Here, based on the voltage values V1 and V2, it is determined whether the balancing relay 42 is to be turned to an on state or an off state. The specified value Vth may be determined, for example, based on the current value flowing due to the difference between the voltage value V1 and the voltage value V2, the permissible current of the components that constitute the circuit (such as the battery cells a, the unit relays 15 and 25, and the like), and the like, when the balancing relay 42 is in an off state and the unit relays 15 and 25 are in an on state.

At step S4, if the difference between the voltage value V1 and the voltage value V2 is greater than or equal to the specified value Vth (Yes), the process proceeds to step S6.

At step S6 shown in FIG. 2, the instruction unit 53 instructs the balancing relay 42 to be turned to an on state. The balancing relay 42 is switched to the on state. This allows the battery unit 10 and the battery unit 20 to be connected in parallel. According to the difference between the voltage value V1 and the voltage value V2, electric current flows from one of the battery unit 10 and the battery unit 20 that has a higher voltage to the other one that has a lower voltage. This serves to reduce the voltage difference between the battery unit 10 and the battery unit 20.

After a predetermined time has elapsed, the acquisition unit 51 acquires the voltage value V1 of the battery unit 10 and the voltage value V2 of the battery unit 20 (S2), and the determination unit 52 determines whether or not the difference between the voltage value V1 and the voltage value V2 is greater than or equal to the specified value Vth (S4). If the difference between the voltage value V1 and the voltage value V2 is greater than or equal to the specified value Vth (Yes), the process described above is repeated. If the difference between the voltage value V1 and the voltage value V2 is not greater than or equal to the specified value Vth (No), it indicates that the remaining capacities of the battery units 10 and 20 are equalized, so the process proceeds to step S9.

At step S9 shown in FIG. 2, the balancing relay 42 is switched to the off state, which ends the equalization of the remaining capacities of the battery units 10 and 20. At the time of starting up the load 90, the unit relays 15 and 25, the pre-charge relay 63, the main relay 60 are switched to the on state in that order. Thereafter, the pre-charge relay 63 is switched to the off state.

In the above-described embodiment, the battery system 1 includes battery units 10 and 20 connected in parallel, battery unit voltage detectors 14 and 24 detecting voltage values of the battery units 10 and 20, a plurality of unit relays 15 and 25 respectively connected in series to the plurality of battery units 10 and 20, and a balancing circuit 40. The battery units 10 and 20 includes, respectively, a plurality of battery cells a connected in series, cell voltage detectors 12 and 22 detecting the respective voltage values of the plurality of battery cells a, and equalizers 13 and 23 equalizing the remaining capacities of the plurality of battery cells a based on the voltage values detected by the cell voltage detectors 12 and 22. The balancing circuit 40 includes a resistor 41. One end of the balancing circuit 40 is connected to a connection point between the battery unit 10 and the unit relay 15 that are connected in series. The other end of the balancing circuit 40 is connected to a connection point between the battery unit 20 and the unit relay 25 that are connected in series.

In such a battery system 1, the battery units 10 and 20 are connected in parallel. The balancing circuit 40 is connected between a connection point between the battery unit 10 and the unit relay 15 and a connection point between the battery unit 20 and the unit relay 25. Such a configuration makes it possible to equalize the remaining capacities of the battery units 10 and 20 even when the unit relays 15 and 25 are in the off state and the battery system 1 is not connected to the load 90. Because the remaining capacities of the battery units 10 and 20 have already been equalized before starting up the battery system 1 connected to the load 90, there is no need to wait for equalization of the remaining capacities between the battery units 10 and 20 at the time of the starting-up. As a result, the starting time of the battery system 1 is shortened. Moreover, the battery system 1 allows the remaining capacities of the battery units 10 and 20 to be equalized with a simpler circuit configuration, without providing a circuit for equalization for each of the battery units 10 and 20. In addition, the battery system 1 is able to equalize the remaining capacities appropriately even with battery cells a having different battery characteristics.

Furthermore, it is sufficient that the battery system 1 may equalize the remaining capacities of the battery units 10 and 20, for example, at such time as before starting-up or during stand-by. This allows for a longer time for the equalization in comparison with in the case where the equalization is carried out at the time of starting-up. Herein, the balancing circuit 40 may be configured so as to reduce the current value during the equalization. For example, it is possible to increase the resistance value of the resistor 41 in the balancing circuit 40 to reduce the amount of heat produced by the resistor 41. This may improve the safety of the battery system 1. In addition, in the case where the balancing circuit 40 is provided with the balancing relay 42, the balancing relay 42 may employ a relay with a smaller size because the current value during the equalization is lower. Thus, the battery system 1 may enable the remaining capacities of the battery units 10 and 20 to be equalized with a simpler circuit configuration.

In the above-described embodiment, the balancing circuit 40 includes the resistor 41 and the balancing relay 42 that are connected in series. Because the balancing circuit 40 is provided with the balancing relay 42, it is possible to control the timing of the equalization for the battery units 10 and 20. For example, it is possible to equalize the battery units 10 and 20 after the equalization of the remaining capacities between the battery cells a that constitute the battery unit 10 and the equalization of the remaining capacities between the battery cells a that constitute the battery unit 20 have both been completed. This serves to appropriately equalize the remaining capacities between the battery units 10 and 20 and the remaining capacities between the battery cells a that constitute each of the battery units 10 and 20.

In the above-described embodiment, the battery system 1 further includes a main relay 60 connected in series to the battery units 10 and 20, which are connected in parallel. The main relay 60 is a relay that switches connection between the battery system 1 and the load 90. The battery system 1 is able to equalize the remaining capacities of the battery units 10 and 20 even when the battery system 1 is not connected to the load 90. The battery system 1 is able to equalize the remaining capacities of the battery units 10 and 20 even such time as before starting-up or during stand-by of the load 90. For example, when the battery system 1 is incorporated in an electric vehicle as an on-board battery, it is possible to equalize the remaining capacities of the battery units 10 and 20 even before the ignition switch is turned on.

In the above-described embodiment, the battery system 1 further includes a controller 50 that controls switching of the balancing relay 42. The controller 50 is configured to execute a process (S2) of acquiring respective voltage values V1 and V2 of the battery units 10 and 20 and a process (S4) of determining whether the balancing relay 42 is turned to an on state or to an off state based on the difference between the voltage values V1 and V2 of the battery units 10 and 20. This eliminates the imbalance in difference between the voltage values V1 and V2 of the battery units 10 and 20 and inhibits inrush current from flowing when the unit relays 15 and 25 are turned to the on state.

According to the above-described embodiment, in the process (S4) of determining, the balancing relay 42 is switched to the off state if the difference between the voltage values V1 and V2 is not greater than or equal to a specified value Vth. This reduces the risk of causing electric current to flow unnecessarily and damaging the battery cells, the unit relays, and the like when the difference between the voltage values V1 and V2 becomes less than or equal to the specified value Vth.

It should be noted that the configuration of the battery system according to the present disclosure is not limited to the above-described configuration of the battery system 1. For example, the battery unit voltage detectors 14 and 24 do not need to be provided respectively in the battery controllers 11 and 21. The battery unit voltage detectors 14 and 24 may be provided, for example, independently from the battery controllers 11 and 21, or may be provided in the controller 50. In addition, the circuit configuration of the battery system is not limited to that of the battery system 1.

### Battery System 1A

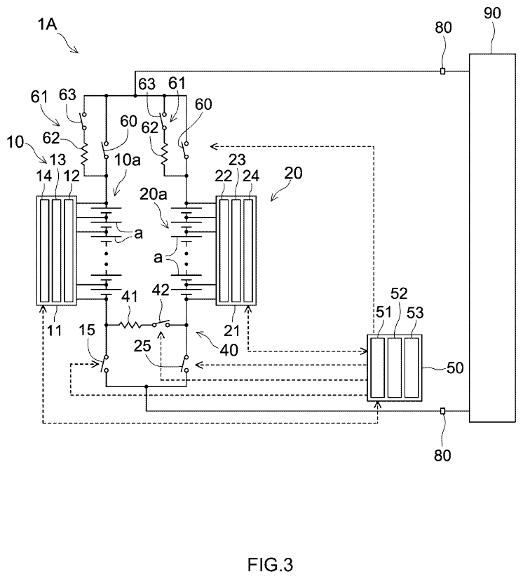

FIG. 3 is a schematic view illustrating a battery system 1A. The configuration of the battery system 1A is the same as that of the battery system 1 except for the main relay 60 and the pre-charge circuit 61 connected in parallel to the main relay 60. Therefore, further detailed descriptions of the constituent components will be omitted herein. As illustrated in FIG. 3, the battery system 1A includes two main relays 60 and two pre-charge circuits 61. In the battery system 1A, the main relays 60 are respectively connected in series to the battery units 10 and 20. In the battery system 1A, a circuit in which the battery unit 10 and a main relay 60 is connected in series and a circuit in which the battery unit 20 and another main relay 60 is connected in series are connected in parallel to each other. By turning the balancing relay 42 to an on state and turning the main relay 60 or the pre-charge relay 63 to an on state, the remaining capacities of the battery units 10 and 20 are equalized even when the unit relays 15 and 25 are in an off state.

In addition, the battery system according to the present disclosure may include three or more battery units.

### Battery System 1B

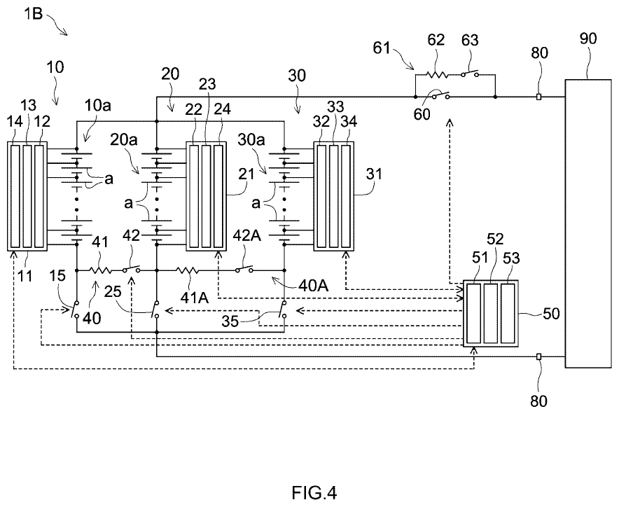

FIG. 4 is a schematic view illustrating a battery system 1B. The configuration of the battery system 1B is the same as that of the battery system 1 except that it further includes a battery unit 30 connected in parallel to the battery units 10 and 20 and that it further includes a balancing circuit 40A. Therefore, further detailed descriptions of the constituent components will be omitted herein. As illustrated in FIG. 4, the battery system 1B includes three battery units 10, 20, and 30 that are connected in parallel.

Similar to the battery units 10 and 20, the battery unit 30 includes a plurality of battery cells a connected in series and a battery controller 31. The battery unit 30 is connected in series to a unit relay 35. The battery controller 31 includes a cell voltage detector 32, an equalizer 33, and a battery unit voltage detector 34. The battery controller 31 is communicably connected to the controller 50. The voltage value of the battery module 30a acquired by the battery unit voltage detector 34 is transmitted to the controller 50.

The balancing circuit 40A includes a resistor 41A and a balancing relay 42A. One end of the balancing circuit 40A is connected to a connection point between the battery unit 20 and the unit relay 25 that are connected in series. The other end of the balancing circuit 40A is connected to a connection point between the battery unit 30 and the unit relay 35 that are connected in series.

Such a battery system 1B also enables the remaining capacities between the battery units 10, 20, and 30 to be equalized. Hereinafter, an example of the process executed by the controller 50 of the battery system 1B is described.

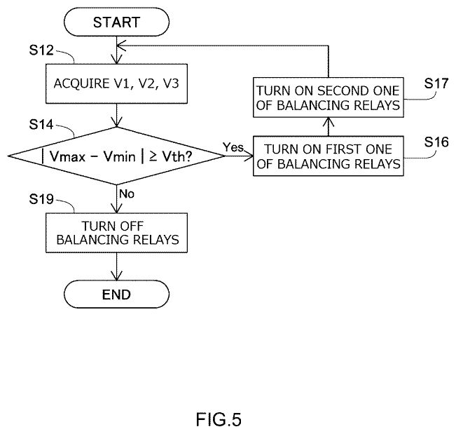

FIG. 5 is a flowchart illustrating a process executed by the controller 50. FIG. 5 shows a flowchart of a process that is executed when the remaining capacities between the battery units 10, 20, and 30 are equalized. In this embodiment, the equalization in remaining capacity between the battery units 10, 20, and 30 is performed before the battery units 10, 20, and 30 of the battery system 1B are connected to the load 90. Before the battery units 10, 20, and 30 are connected to the load 90, the main relay 60, the pre-charge relay 63, the unit relays 15, 25, and 35 and the balancing relays 42 and 42A are in an off state.

At step S12 shown in FIG. 5, the acquisition unit 51 acquires the voltage value V1 of the battery unit 10, the voltage value V2 of the battery unit 20, and the voltage value V3 of the battery unit 30.

At step S14 shown in FIG. 5, the determination unit 52 determines whether or not the difference between the highest voltage value Vmax and the lowest voltage value Vmin among the voltage values V1, V2, and V3, which are acquired by the acquisition unit 51, is greater than or equal to a predetermined specified voltage value Vth. Here, based on the voltage values V1, V2, and V3, it is determined whether the balancing relays 42 and 42A are to be turned to an on state or an off state.

At step S14, if the difference between the voltage value Vmax and the voltage value Vmin is greater than or equal to the specified value Vth (Yes), the process proceeds to step S16.

At step S16 shown in FIG. 5, the instruction unit 53 instructs the balancing relay 42 to be turned to an on state. The balancing relay 42 is switched to the on state. Subsequently, at step S17 shown in FIG. 5, the instruction unit 53 instructs the balancing relay 42A to be turned to an on state. The balancing relay 42A is switched to the on state. This allows the battery unit 10, the battery unit 20, and the battery unit 30 to be connected in parallel. According to the difference between the voltage values V1, V2, and V3, electric current flows from one of the battery units 10, 20, and 30 that has a higher voltage value to another one that has a lower voltage. This serves to reduce the voltage difference between the battery units 10, 20, and 30.

After a predetermined time has elapsed, the acquisition unit 51 acquires the respective voltage values V1, V2, and V3 of the battery units 10, 20, and 30 (S12), and the determination unit 52 determines whether or not the difference between the voltage value Vmax and the voltage value Vmin is greater than or equal to the specified value Vth (S14). If the difference between the voltage value Vmax and the voltage value Vmin is greater than or equal to the specified value Vth (Yes), the process described above is repeated. If the difference between the voltage value Vmax and the voltage value Vmin is not greater than or equal to the specified value Vth (No), it indicates that the remaining capacities of the battery units 10, 20, and 30 are equalized, so the process proceeds to step S19. At step S19 shown in FIG. 5, the balancing relays 42 and 42A are switched to the off state, which ends the equalization of the remaining capacities of the battery units 10, 20, and 30.

It should be noted that the order in which the balancing relays 42 and 42A are to be switched is not particularly limited. It is possible that the balancing relay 42 may be switched to the on state after the balancing relay 42A has been switched to the on state. However, from the viewpoint of distribute the power consumption necessary to drive the balancing relays 42 and 42A, it is preferable that the balancing relays 42 and 42A be switched at different times.

In the above-described battery system 1B, the balancing circuits 40 and 40A are provided so as to connect the adjacent battery units 10, 20, and 30 to each other. However, it is also possible that, in a battery system including three or more battery units, a balancing circuit may be provided for each of the three or more battery units.

### Battery System 1C

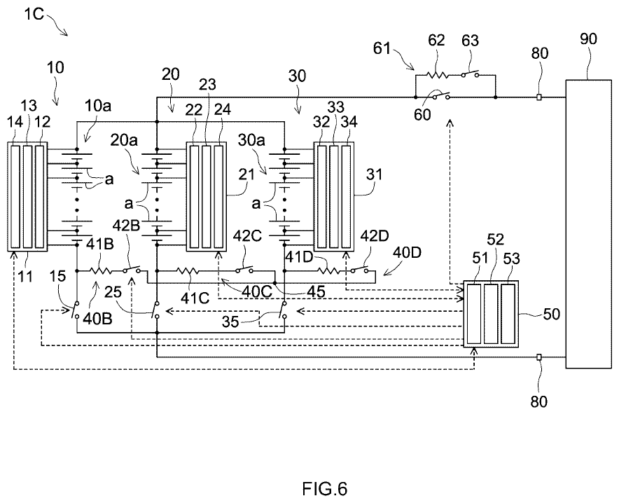

FIG. 6 is a schematic view illustrating a battery system 1C. As illustrated in FIG. 6, the battery system 1C includes three balancing circuits 40B, 40C, and 40D. The balancing circuits 40B, 40C, and 40D respectively include resistors 41B, 41C, and 41D and balancing relays 42B, 42C, and 42D. The balancing circuits 40B, 40C, and 40D are provided correspondingly to three battery units 10, 20, and 30. One end of each of the balancing circuits 40B, 40C, and 40D is connected to a respective one of the connection points between the battery units 10, 20, and 30 and the unit relays 15, 25, and 35. The other end of each of the balancing circuits 40B, 40C, and 40D is connected to a connection point 45. This means that the other end of the balancing circuit 40B is connected via the other balancing circuits 40C and 40D to a connection point between the battery units 20, 30 and the unit relays 25, 35 that are connected in series. Likewise, the other end of the balancing circuit 40C is connected via the other balancing circuits 40B and 40D to a connection point between the battery units 10, 30 and the unit relays 15, 35 that are connected in series. The other end of the balancing circuit 40D is connected via the other balancing circuits 40B and 40C to a connection point between the battery units 10, 20 and the unit relays 15, 25 that are connected in series. Hereinafter, an example of the process executed by the controller 50 of the battery system 1C is described.

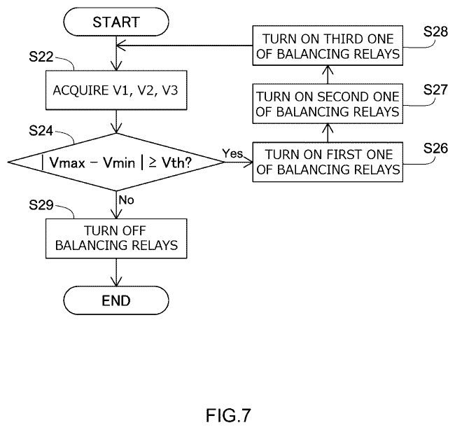

FIG. 7 is a flowchart illustrating a process executed by the controller 50. FIG. 7 shows a flowchart of a process that is executed when the remaining capacities between the battery units 10, 20, and 30 are equalized. Herein, a process that is executed before the battery units 10, 20, and 30 are connected to the load 90 is described, as with the battery system 1B. Before the battery units 10, 20, and 30 are connected to the load 90, the main relay 60, the pre-charge relay 63, the unit relays 15, 25, and 35 and the balancing relays 42B, 42C, and 42D are in an off state.

At step S22 shown in FIG. 7, the acquisition unit 51 acquires the voltage value V1 of the battery unit 10, the voltage value V2 of the battery unit 20, and the voltage value V3 of the battery unit 30.

At step S24 shown in FIG. 7, the determination unit 52 determines whether or not the difference between the highest voltage value Vmax and the lowest voltage value Vmin among the voltage values V1, V2, and V3, which are acquired by the acquisition unit 51, is greater than or equal to a predetermined specified voltage value Vth. Here, based on the voltage values V1, V2, and V3, it is determined whether the balancing relays 42B, 42C, and 42D are to be turned to an on state or an off state.

At step S24, if the difference between the voltage value Vmax and the voltage value Vmin is greater than or equal to the specified value Vth (Yes), the process proceeds to step S26.

At step S26 shown in FIG. 7, the instruction unit 53 instructs the balancing relay 42B to be turned to an on state. The balancing relay 42B is switched to the on state. Subsequently, at step S27 shown in FIG. 7, the instruction unit 53 instructs the balancing relay 42C to be turned to an on state. The balancing relay 42C is switched to the on state. Subsequently, at step S28 shown in FIG. 7, the instruction unit 53 instructs the balancing relay 42D to be turned to an on state. The balancing relay 42D is switched to the on state. This allows the battery unit 10, the battery unit 20, and the battery unit 30 to be connected in parallel. According to the difference between the voltage values V1, V2, and V3, electric current flows from one of the battery units 10, 20, and 30 that has a higher voltage value to another one that has a lower voltage. This serves to reduce the voltage difference between the battery units 10, 20, and 30.

After a predetermined time has elapsed, the acquisition unit 51 acquires the respective voltage values V1, V2, and V3 of the battery units 10, 20, and 30 (S22), and the determination unit 52 determines whether or not the difference between the voltage value Vmax and the voltage value Vmin is greater than or equal to the specified value Vth (S24). If the difference between the voltage value Vmax and the voltage value Vmin is greater than or equal to the specified value Vth (Yes), the process described above is repeated. If the difference between the voltage value Vmax and the voltage value Vmin is not greater than or equal to the specified value Vth (No), it indicates that the remaining capacities of the battery units 10, 20, and 30 are equalized, so the process proceeds to step S29. At step S29 shown in FIG. 7, the balancing relays 42 and 42A are switched to the off state, which ends the equalization of the remaining capacities of the battery units 10 and 20. It should be noted that the order in which the balancing relays 42B, 42C, and 42D are to be switched is not particularly limited.

The battery system 1C is able to equalize the remaining capacities of a given combination of battery units 10, 20, and 30 by switching the balancing relays 42B, 42C, and 42D between an on state and off state. The order in which the balancing relays 42B, 42C, and 42D are switched may be, but is not particularly limited to, determined according to the voltage difference between the battery units 10, 20, and 30. From the viewpoint of reducing the current produced when performing the equalization, it is possible that switching the balancing relays 42B, 42C, and 42D may be controlled so that battery units with a smaller difference are connected in parallel among the battery units 10, 20, and 30. From the viewpoint of completing the equalization more quickly, it is possible that switching the balancing relays 42B, 42C, and 42D may be controlled so that battery units with a greater difference are connected in parallel among the battery units 10, 20, and 30.

Various embodiments of the technology according to the present disclosure have been described hereinabove. Unless specifically stated otherwise, the embodiments described herein do not limit the scope of the present disclosure. It should be noted that various other modifications and alterations may be possible in the embodiments of the technology disclosed herein. In addition, the features, structures, or steps described herein may be omitted as appropriate, or may be combined in any suitable combinations, unless specifically stated otherwise. In addition, the present description includes the disclosure as set forth in the following items.

### Item 1:

A battery system including:
a plurality of battery units connected in parallel;
a battery unit voltage detector detecting a voltage value of each of the plurality of battery units;
a plurality of unit relays respectively connected in series to the plurality of battery units; and
at least one balancing circuit, wherein:
each of the plurality of battery units includes a plurality of battery cells connected in series, a cell voltage detector detecting respective voltage values of the plurality of battery cells, and an equalizer equalizing remaining capacities of the plurality of battery cells based on the voltage values detected by the cell voltage detector;
the balancing circuit includes a resistor;
one end of the balancing circuit is connected to a connection point between one of the battery units and one of the unit relays, the one of the battery units and the one of the unit relays being connected in series to each other; and
the other end of the balancing circuit is connected to a connection point between another one of the battery units and another one of the unit relays, the other one of the battery units and the other one of the unit relays being connected in series to each other.

### Item 2:

The battery system according to item 1, wherein the balancing circuit includes a balancing relay connected in series to the resistor.

### Item 3:

The battery system according to item 2, further including a main relay connected in series to the plurality of parallel connected battery units.

### Item 4:

The battery system according to item 2, further including respective main relays respectively connected in series to the plurality of parallel connected battery units.

### Item 5:

The battery system according to any one of items 2 to 4, further including:
a controller controlling switching of the balancing relay, wherein:
the controller is configured to execute:
   a process of acquiring respective voltage values of the plurality of battery units; and
   a process of determining whether the balancing relay is turned to an on state or an off state, based on a difference between the voltage values between the plurality of battery units.

### Item 6:

The battery system according to item 5, wherein the process of determining includes switching the balancing relay to the off state if the difference between the voltage values is not greater than or equal to a predetermined specified value.

### Item 7:

The battery system according to any one of items 2 to 6, further including:
a plurality of balancing circuits, wherein:
one end of one of the plurality of balancing circuits is connected to a connection point between one of the battery units and one of the unit relays, the one of the battery units and the one of the unit relays being connected in series to each other, and
the other end of the one of the plurality of balancing circuits is connected to a connection point between another one of the battery units and another one of the unit relays, the other one of the battery units and the other one of the unit relays being connected in series to each other.

What is claimed is:

1. A battery system comprising:
a plurality of battery units connected in parallel;
a battery unit voltage detector detecting a voltage value of each of the plurality of battery units;
a plurality of unit relays respectively connected in series to the plurality of battery units; and
at least one balancing circuit, wherein:
each of the plurality of battery units includes a plurality of battery cells connected in series, a cell voltage detector detecting respective voltage values of the plurality of battery cells, and an equalizer equalizing remaining capacities of the plurality of battery cells based on the voltage values detected by the cell voltage detector;
the balancing circuit includes a resistor;
one end of the balancing circuit is connected to a connection point between one of the battery units and one of the unit relays, the one of the battery units and the one of the unit relays being connected in series to each other; and
the other end of the balancing circuit is connected to a connection point between another one of the battery units and another one of the unit relays, the other one of the battery units and the other one of the unit relays being connected in series to each other.

2. The battery system according to claim 1, wherein the balancing circuit includes a balancing relay connected in series to the resistor.

3. The battery system according to claim 2, further comprising a main relay connected in series to the plurality of parallel connected battery units.

4. The battery system according to claim 2, further comprising respective main relays respectively connected in series to the plurality of parallel connected battery units.

5. The battery system according to claim 2, further comprising:
a controller controlling switching of the balancing relay, wherein:
the controller is configured to execute:
a process of acquiring respective voltage values of the plurality of battery units; and
a process of determining whether the balancing relay is turned to an on state or an off state, based on a difference between the voltage values between the plurality of battery units.

6. The battery system according to claim 5, wherein the process of determining includes switching the balancing relay to the off state if the difference between the voltage values is not greater than or equal to a predetermined specified value.

7. The battery system according to claim 2, further comprising:
a plurality of balancing circuits, wherein:
one end of one of the plurality of balancing circuits is connected to a connection point between one of the battery units and one of the unit relays, the one of the battery units and the one of the unit relays being connected in series to each other; and
the other end of the one of the plurality of balancing circuits is connected to a connection point between another one of the battery units and another one of the unit relays, the other one of the battery units and the other one of the unit relays being connected in series to each other.
